(19) United States
(12) Patent Application Publication
(10) Pub. No.: US 2017/0087579 A1
(43) Pub. Date: Mar. 30, 2017

(54) HOSE HOLDER

(71) Applicant: Sal A. DeRaffele, Hartsdale, NY (US)

(72) Inventor: Sal A. DeRaffele, Hartsdale, NY (US)

(21) Appl. No.: 14/866,208

(22) Filed: Sep. 25, 2015

(51) Int. Cl. B05B 15/06; B60R 11/00; F16B 1/00

(52) U.S. Cl. CPC B05B 15/061; F16B 1/00; B60R 11/00; F16B 2001/0028; F16B 2001/0035; B60R 2011/0059; B60R 2011/0057; B60R 2011/0063; B60R 2011/0071; B60R 2011/004

(57) ABSTRACT

A method and device for holding a nozzle of a hose above ground level by securing it to a portion of a vehicle, for example, a side view mirror of a vehicle. A strap is provided that can be removably attached to a side view minor of a vehicle. The strap is adjustable so that it can be attached to side view mirrors having various shapes and sizes. A support is supported by the strap so that a hose nozzle can be removably selectively supported by the strap.

### FIELD OF THE INVENTION

The present invention concerns accessories for car washing. More particularly, the invention concerns a device for holding a hose nozzle.

### BACKGROUND OF THE INVENTION

Car owners that wash their cars at home typically use a hose with a spray nozzle, a bucket with soap and water, and a sponge. The hose and nozzle are often used to wet down the car before washing with the sponge, to rinse the car once washing is complete, and can be used for intermediate rinsing of the car as washing is progressing.

One problem that can arise during the car washing process relates to a user having to repeatedly place the hose and nozzle on the ground when not in use and to have to bend down and retrieve the hose from the ground to use it. The process of repeatedly bending down can cause strain and stress to a user. In addition, repeatedly dropping a hose nozzle on the ground can cause damage to the nozzle. It can also result in the nozzle being inadvertently activated by contact with the ground, which can cause a user to accidently be sprayed. These problems cause inefficiencies in the process of washing a car.

The present invention addresses these problems by providing a device and method for securing a hose nozzle to a side view minor of a vehicle.

### SUMMARY OF THE INVENTION

According to an embodiment, a method of securing a hose to a vehicle is provided. The method includes the steps of providing a hose holder. The hose holder includes a resilient web of material having first and second end portions. Releasable attachments are disposed on the first and second end portions of the resilient web of material and permit securement of the first and second end portions to each other. A resilient support is connected to the resilient web of material. The resilient support is sized and shaped to receive and selectively support a hose nozzle. The resilient support is adapted to resiliently deform upon receiving the hose nozzle from an unbiased state. The method further includes the steps of disposing the resilient web of material of the hose holder about a portion of the vehicle, securing the first and second ends of the web of material of the hose holder to each other and around a portion of the vehicle such that the web of material is supported by the portion of the vehicle, and urging a hose nozzle into the resilient support of the hose holder so as to deform the resilient support such that the hose nozzle is supported by the resilient support.

According to a further embodiment, the resilient web of material of the hose holder is shaped to be disposed around and complement at least a portion of a side-view minor.

According to a further embodiment, the method includes the step of advancing the hose nozzle until the resilient support at least partially returns to the unbiased state.

According to a further embodiment, the disposing step further includes positioning a non-marring surface of the web against a side-view mirror.

According to a further embodiment, the resilient support is a spring loop sized and shaped to receive a hose nozzle within the loop.

According to a further embodiment, the spring loop is supported at an upper point and a lower point.

According to a further embodiment, the resilient support is bent metal receptacle sized and shaped to receive a hose nozzle within the loop.

According to a yet further embodiment, the resilient support is bent metal receptacle includes two upright portions connected at adjacent ends by a curved portion, wherein the curved portion allows the two upright portions to flex away from each other to receive and secure a hose nozzle.

According to a further embodiment, the releasable attachments are hook and loop fasteners.

According to a further embodiment, the resilient web of material is a stretchable fabric. According to a further embodiment, the resilient web of material is neoprene. According to a further embodiment, the resilient web of material includes a non-slip surface arranged to contact the side-view minor when the web of material is disposed thereabout.

According to an embodiment, a hose holder is provided that includes a resilient web of material having first and second end portions, releasable attachments disposed on the first and second end portions that permit securement of the first and second end portions to each other, and a resilient support connected to the resilient web of material, the resilient support sized and shaped to receive and selectively support a hose nozzle, the resilient support adapted to resiliently deform upon receiving the hose nozzle.

According to an embodiment, a method of securing a hose to a vehicle is provided. The steps include providing a hose holder. The hose holder includes a resilient web of material having first and second end portions and releasable attachments disposed on the first and second end portions that permit securement of the first and second end portions to each other. The hose holder includes a first support connected to the resilient web of material and a second support sized and shaped to be connected to a hose nozzle, wherein the first and second supports are configured for releasable engagement. The method further includes disposing the resilient web of material of the hose holder about a portion of the vehicle, securing the first and second ends of the web of material of the hose holder to each other and around the portion of the vehicle such that the web of material is supported by the portion of the vehicle, securing the second support to a nozzle of a hose, and engaging the first and second supports.

According to a further embodiment, the resilient web of material of the hose holder is shaped to complement at least a portion of a side-view mirror of the vehicle.

According to a further embodiment, the disposing step further comprises positioning a non-marring surface of the web against the vehicle.

According to a further embodiment, the releasable attachments are hook and loop fasteners.

According to a further embodiment, the first and second supports include a hook and loop adapted for releasable engagement.

According to a further embodiment, the first and second supports include magnets adapted for releasable engagement.

According to a further embodiment, the first and second supports include a hook and loop fasteners adapted for releasable engagement.

### DESCRIPTION OF THE DRAWING FIGURES

FIG. 1 is an isometric view of the hose nozzle holder device;

FIG. 2 is an isometric view of a portion of the hose nozzle holder device;

FIG. 3 is an isometric view of the hose nozzle holder device;

FIG. 4 is an isometric view of the hose nozzle holder device according to another embodiment;

FIG. 5 is an isometric view a portion of the hose nozzle holder device of FIG. 4;

FIG. 6 is front view of the hose nozzle holder device of FIG. 4 in a first condition;

FIG. 7 is front view of the hose nozzle holder device of FIG. 4 in a second condition;

FIG. 8 is side view of a portion of the hose nozzle holder device of FIG. 4;

FIG. 9 is an isometric view of the hose nozzle holder device according to another embodiment;

FIG. 10 is an isometric view of the hose nozzle holder device according to another embodiment;

FIG. 11 is an isometric view of the hose nozzle holder device according to another embodiment;

FIG. 12 is side view of the hose nozzle holder device of FIG. 11; and

FIGS. 13 A and B are isometric views of a portion of the hose nozzle holder device of FIG. 1.

### DETAILED DESCRIPTION OF CERTAIN EMBODIMENTS OF THE INVENTION

By way of overview and introduction, the present invention is described in detail in connection with hose nozzle holding device and method.

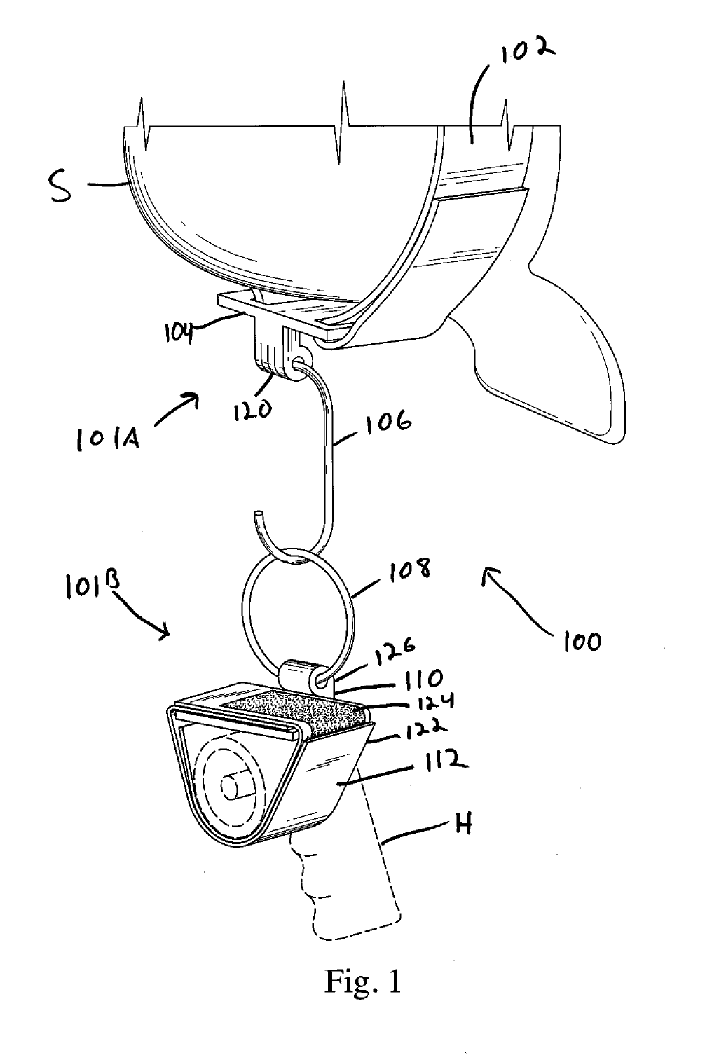

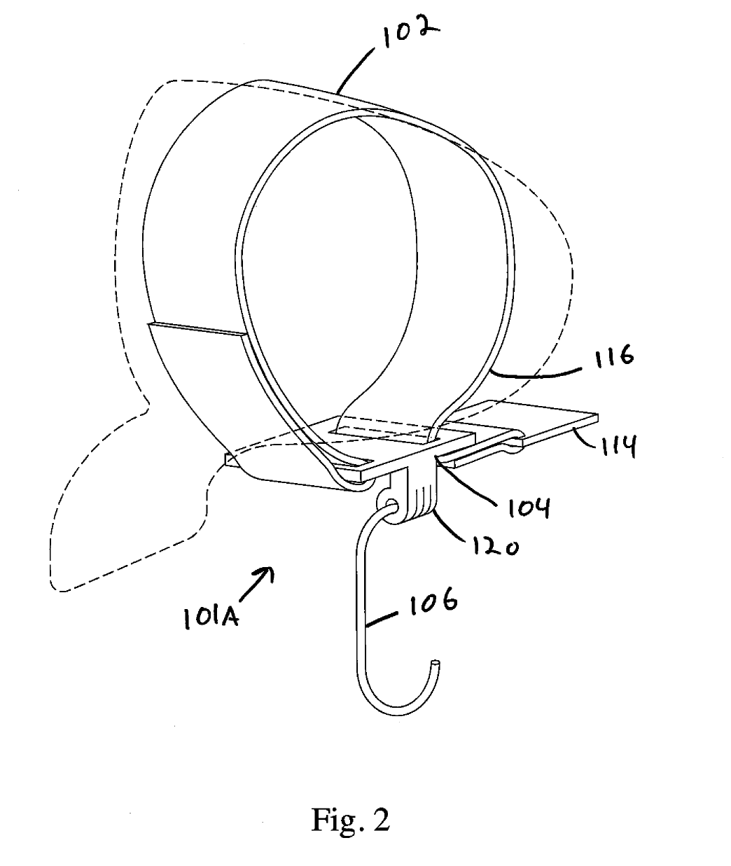

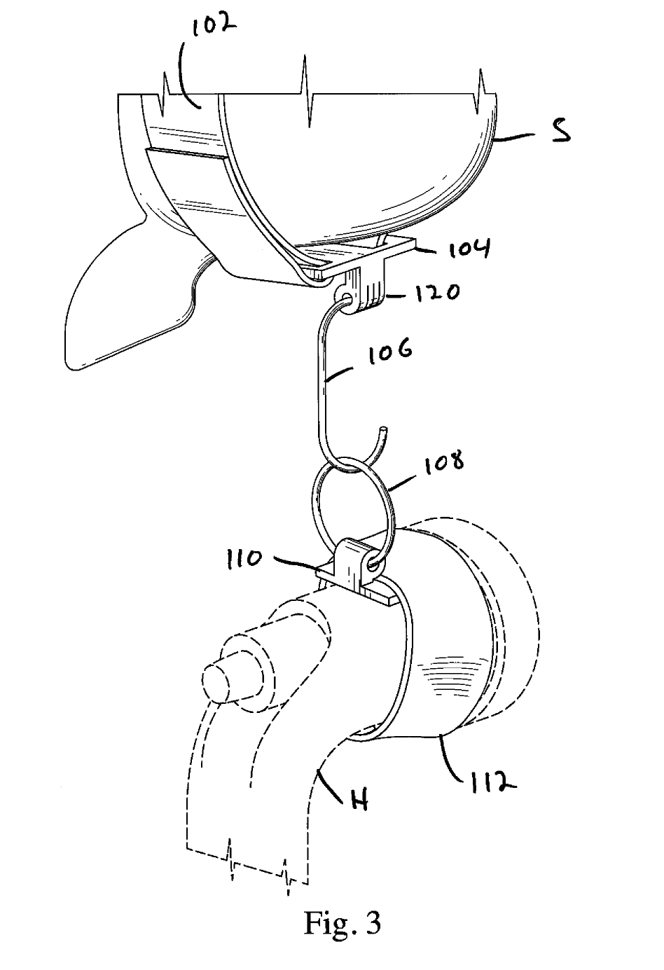

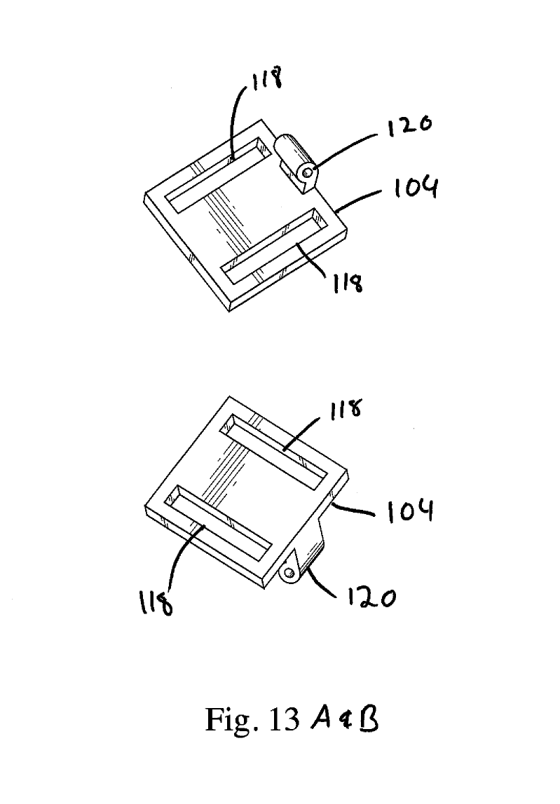

In one embodiment, referring to FIGS. 1-3 and 13A-B, a hose nozzle holding device 100 is shown. The hose nozzle holding device 100 includes a first adjustable strap 102, a first support 104, a hook 106, a loop 108, a second support 110, and a second strap 112. The first strap 102, which is a resilient web of material, is sized and shaped to fit around a side view mirror S of a vehicle. The strap 102 is wrapped around a side view mirror and anchors the holding device 100 to the vehicle. Since a side view mirror of a vehicle is typically at a convenient height above the ground within a user's reach, a side view mirror provides a suitable anchoring point for supporting the hose nozzle holding device 100. The strap 102 can be made from a water resistant material that resists slipping, such as neoprene, rubber, rubberized fabric, etc. The strap 102 can also have a degree of stretchiness so that it conforms to the various shapes of side view minors of various vehicles (e.g., cars, trucks, etc.). The strap 102 has a length such that it can be wrapped around side view mirrors of various sizes for different vehicle types. The securement of the strap 102 is also adjustable so that it can be securely fastened to a side view minor. For example, the strap 102 can include a hook and loop fastener system such that first portion 114 of the strap can be removably attached to a second portion 116 of the strap. Accordingly, the length and tightness of the strap can be adjusted by adjusting the attachment point of the fasteners. Clips, snaps, buckles, and hooks are other suitable removable and adjustable fasteners. Additionally, the material of the strap (e.g., neoprene, rubberized fabric) is generally soft and non-marring so that it does not scratch or otherwise damage the side view minor of the vehicle. The strap 102 can also include a rubber-like lining material on its inner surface which both grips the side view minor and also prevents damage thereto. The strap 102 is adjustable and versatile such that it can be attached at other points on a vehicle including, for example, a door handle, roof rack, accessory light, or other suitable attachment points such that the strap can be attached to various portions of a vehicle.

A first support 104 is supported by the strap 102. The first support 104 can include attachment means 118 that connect the support 104 to the strap. The support 104 includes a protrusion 120 that supports hook 106. The support 104, protrusion 120, and hook 106 can be integrally formed or can be separate pieces that are connected to one another.

The strap 102, first support 104, and hook 106 form a first portion 101A of the hose nozzle supporting device 100 that is adapted to remain attached to the side view mirror during use. A second portion 101B of the device includes the loop 108, second support 110, and second strap 112 is adapted to remain attached to a hose nozzle H during use.

The second strap 112 is wrapped around a hose nozzle H. The strap 112 can be made from a water resistant material that resists slipping, such as neoprene, rubber, rubberized fabric, etc. The strap 112 can also have a degree of stretchiness so that it conforms to the various shapes of different hose nozzles. The strap 112 has a length so that it can be wrapped around hose nozzles of various sizes and is adjustable so that the strap can be securely disposed about the nozzle. For example, the strap 112 can include a hook and loop fastener system such that a first portion 122 of the strap can removably attached to a second portion 124 of the strap. Accordingly, the length and tightness of the strap can be adjusted by adjusting the attachment point of the fasteners. Clips, snaps, and hooks are other suitable removable and adjustable fasteners. The strap 112 can also include a rubber-like lining material on its inner surface which can improve the grip between the strap 112 and the hose nozzle H.

A second support 110 is supported by the strap 112. The second support can be similar in construction to the first support 104 and can include attachment means 118 that connect the support 110 to the strap 112. The support 110 includes a protrusion 126 that supports loop 108. The support 110, protrusion 126, and loop 108 can be integrally formed or can be separate pieces that are connected to one another. The loop 108 is sized and shaped such that it can be supported by the hook 106 and be readily removed therefrom by a user. The position of the hook and loop can be reversed without departing from the scope of the invention.

The hook 106 and loop 108 provide releasable engagement between the first and second supports, 104 and 110. Other structures can be included that provide for releasable engagement between the first and second supports. For example, magnets, snaps, clips, hook and loop fasteners, or other suitable fasteners that provide for releasable engagement between the first and second parts of the hose nozzle holder device can be used.

In use, a user attaches the first portion 101A of the device 100 to a side view minor of a car to be washed. The adjustable strap 102 is wrapped around the mirror and secured via the adjustable fasteners. A user can then attach the second portion 101B of the device to a hose nozzle via the second adjustable strap 112. The second adjustable strap 112 is wrapped around the hose nozzle and secured via the adjustable fasteners. Accordingly, the first portion 101A is secured to the side view minor and the second portion 101B is secured to the nozzle. The nozzle can be supported above the ground by engaging the hook 106 with the loop 108 of the two portions of the device. When the hose is required for use, the user can disengage the hook 106 and loop 108 so that the hose nozzle is free to move and spray water on the vehicle. When the hose is no longer required, the user can reengage the hook 106 and loop 108 so that the hose nozzle is stowed above the ground at a convenient location for the user until the next required use. When the cleaning of the vehicle is complete, the first strap 102 can be removed from the side view mirror and the second strap 112 can be removed from the hose nozzle.

In certain situations, it is advantageous for the hose nozzle holder device 100 to have a construction such that there is an automatic separation between the hose nozzle and the vehicle to which it is attached. The attachment between the first and second portions of the device can be automatically releasable once a force threshold is reached. For example, if a user forgets to remove the device from the car before attempting to drive away, the first and second portion can disengage at a force threshold so that damage to the hose and/or car is prevented. The releasable attachment between the first and second supports, for example, can be frangible or set to disengage at a certain force (e.g., magnets that are selected to disengage at a threshold force). In addition, the strap 102 and/or strap 112 can be designed to disengage at a threshold force. For example, the strap 102 and/or strap 112 can be frangible, shaped to slip off the vehicle and/or hose nozzle, and/or the releasable attachment of the straps can be designed to disengage at a threshold force.

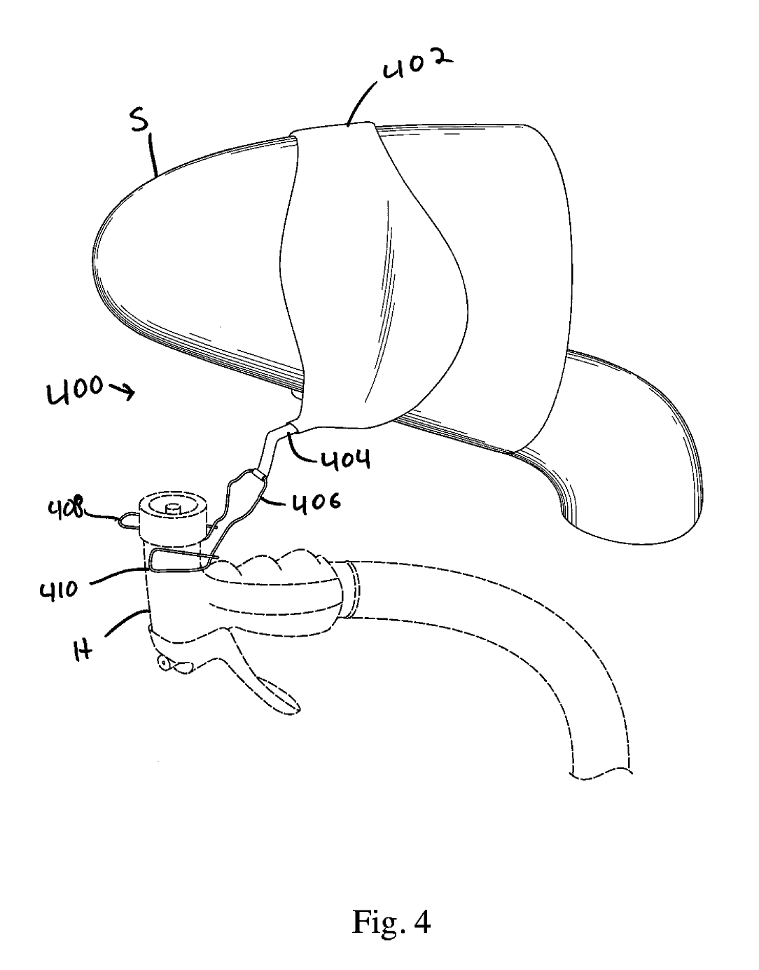

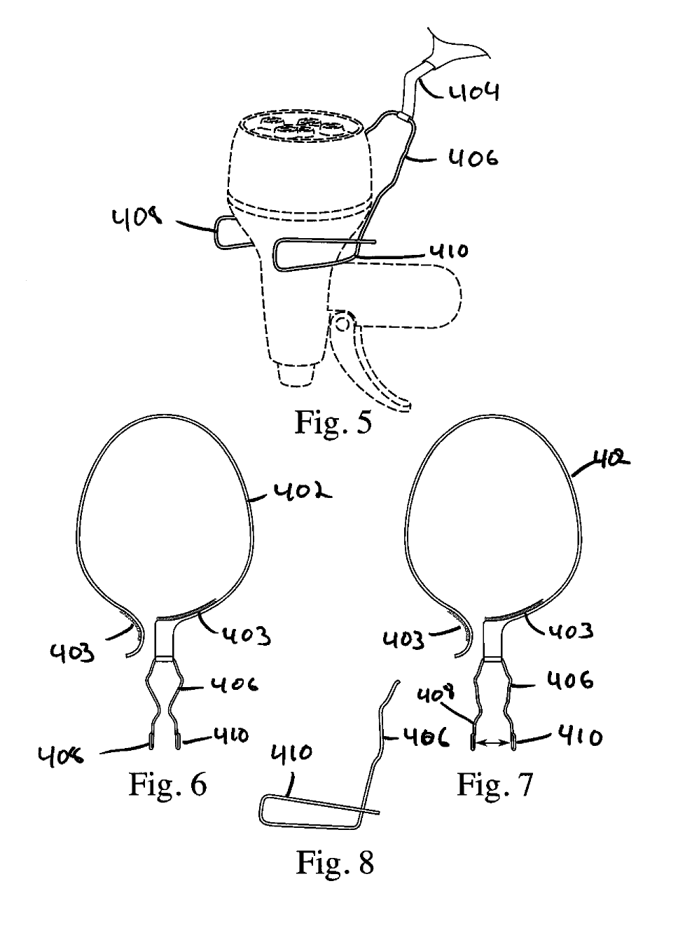

Referring to FIGS. 4-8, a hose nozzle holder 400 according to another embodiment is shown. A strap 402 similar to strap 102 is provided to adjustably wrap around and secure to a side view mirror of a vehicle. The strap 402 includes a removable fastener 403 so that the strap can be tightly secured around side view mirrors of various sizes and shapes. A support 404 is supported by the strap 402. A two-pronged spring clip 406 is supported by the support 404. The prongs 408 and 410 of the spring clip are sized and spaced to receive a hose nozzle therebetween. Referring specifically to FIGS. 6 and 7, FIG. 6 illustrates the spring clip 106 in its normal position in which there is no nozzle disposed between the two prongs 408 and 410. As a nozzle is introduced between the two prongs, the prongs can deform and spread apart from each other (as illustrated by the arrow in FIG. 7) so that hose nozzles of various shapes and sizes can be received between and supported snuggly by the spring clip 106. Accordingly, when the hose is not in use the nozzle is inserted between the two prongs which deform to accept and securely hold the nozzle. When the hose is required, the nozzle can be removed from between the two prongs which return to their normal, non-deformed state.

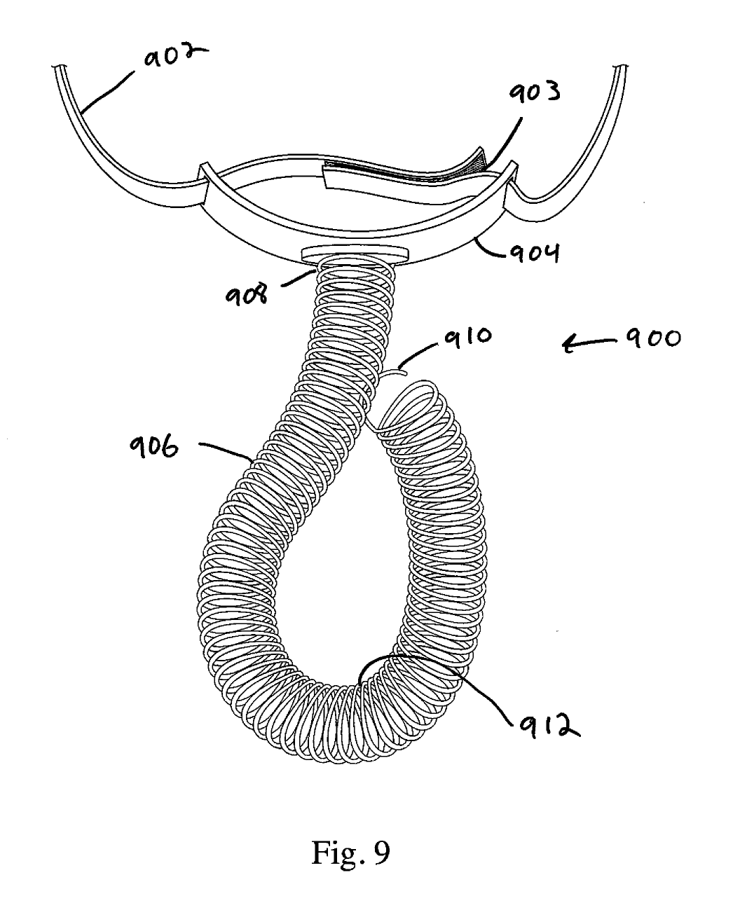

Referring to FIG. 9, a hose nozzle holder 900 according to another embodiment is shown. A strap 902 similar to strap 102 is provided to adjustably wrap around and secure to a side view minor of a vehicle. The strap 902 includes a removable and adjustable fastener 903 so that the strap can be tightly secured around side view mirrors of various sizes and shapes. A support 904 is supported by the strap 902. A spring 906 is supported by the support 904. One end of the spring 908 is attached to the support 904 and the other end 910 of the spring is attached to itself to form a loop. As a nozzle is introduced into the loop, the spring can deform and spread apart so that hose nozzles of various shapes and sizes can be received in the loop. Accordingly, when the hose is not in use the nozzle is inserted into the spring which deforms to accept and securely hold the nozzle. When the hose is required, the nozzle can be removed from the spring loop which returns to its normal, non-deformed state.

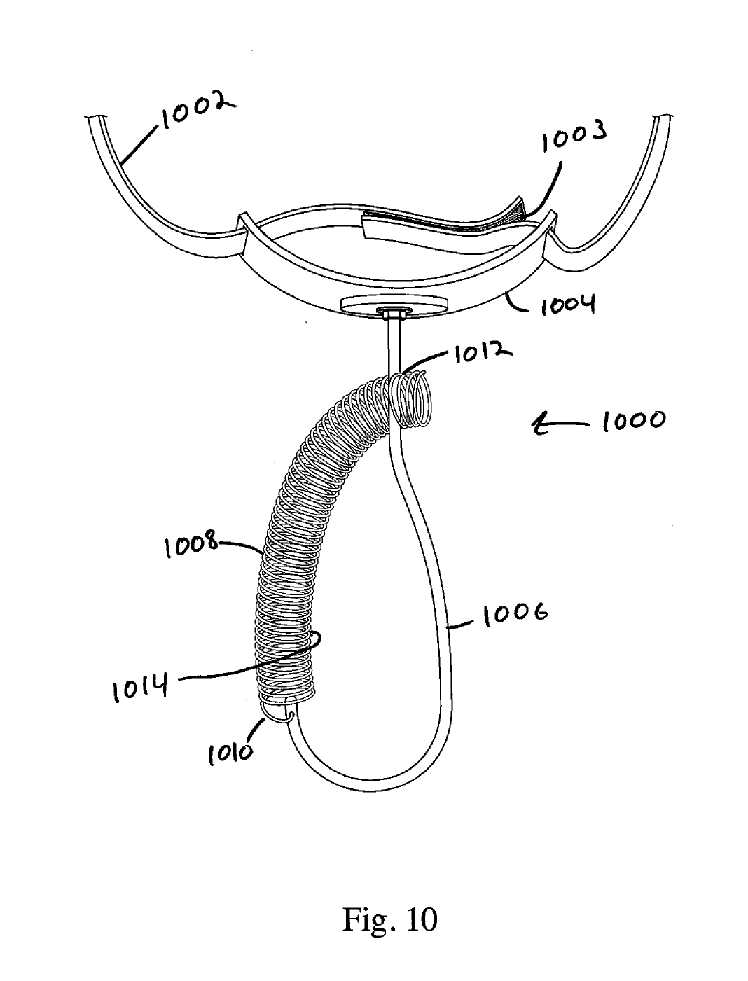

Referring to FIG. 10, a hose nozzle holder 1000 according to another embodiment is shown. A strap 1002 similar to strap 102 is provided to adjustably wrap around and secure to a side view mirror of a vehicle. The strap 1002 includes a removable and adjustable fastener 1003 so that the strap can be tightly secured around side view minors of various sizes and shapes. A support 1004 is supported by the strap 1002. A hook 1006 is supported by the support 1004. A spring 1008 is supported by the hook 1006. One end of the spring 1010 is attached to the hook 1006 and the other end of the spring 1012 is attached to another section of the hook 1006 to form a loop. As a nozzle is introduced into the loop, the spring can deform and spread apart so that hose nozzles of various shapes and sizes can be received in the loop. Accordingly, when the hose is not in use the nozzle is inserted into the spring which deforms to accept and securely hold the nozzle. When the hose is required, the nozzle can be removed from the spring loop which returns to its normal, non-deformed state. The hook 1006 provides increased rigidity to the device which allows the nozzle to be inserted and removed with greater ease.

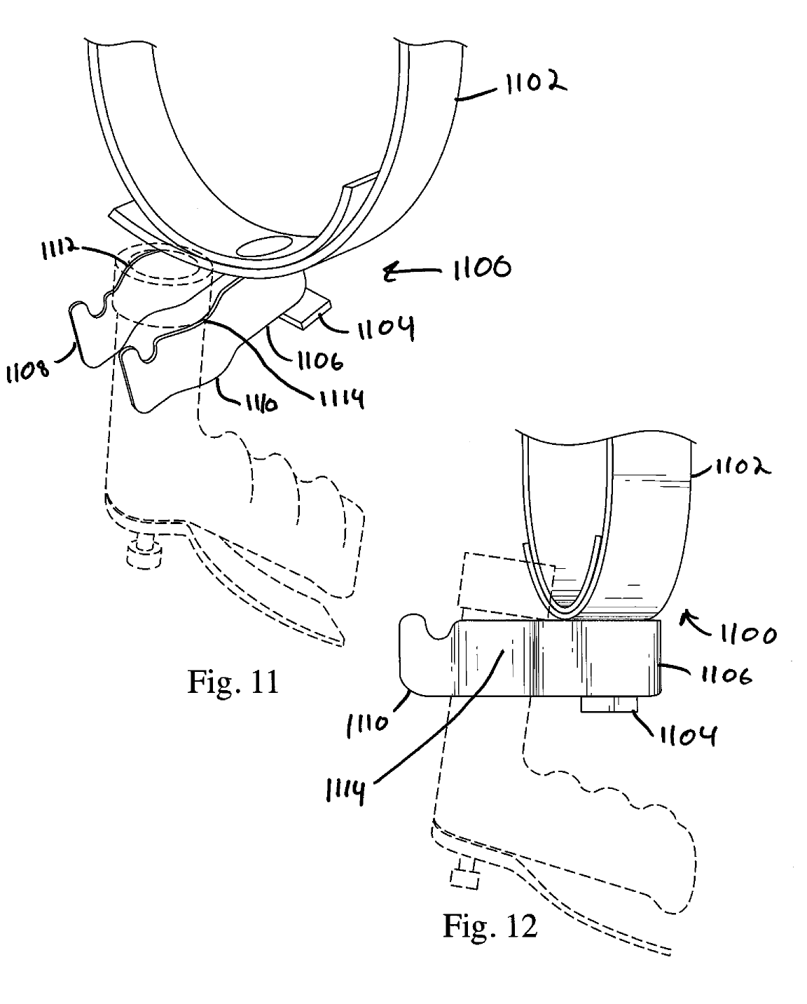

Referring to FIGS. 11-12, a hose nozzle holder 1100 according to another embodiment is shown. A strap 1102 similar to strap 102 is provided to adjustable wrap around and secure to a side view mirror of a vehicle. The strap 1102 includes a removable and adjustable fastener so that the strap can be tightly secured around side view mirrors of various sizes and shapes. A support 1104 is supported by the strap 402. A two-pronged spring clip 1106 is supported by the support 1104. The prongs 1108 and 1110 of the spring clip are sized and spaced to receive a hose nozzle therebetween. The prongs 1108 and 1110 can be spring bands that have bowed sidewalls 1112 and 1114 that provide a pocket for receiving the nozzle once inserted between the prongs 1108 and 1110. As a nozzle is introduced between the two prongs, the prongs can deform and spread apart from each other so that hose nozzles of various shapes and sizes can be received between and supported snuggly by the spring clip 1106. Accordingly, when the hose is not in use the nozzle is inserted between the two prongs which deform to accept and securely hold the nozzle. When the hose is required, the nozzle can be removed from between the two prongs which return to their normal, non-deformed state.

While the invention has been described in connection with certain embodiments thereof, the invention is not limited to the described embodiments but rather is more broadly defined by the recitations in any claims that follow and equivalents thereof.

I claim:

1. A method of securing a hose to a vehicle, comprising the steps of:
providing a hose holder comprising:
a resilient web of material having first and second end portions;
releasable attachments disposed on the first and second end portions that permit securement of the first and second end portions to each other; and
a resilient support connected to the resilient web of material, the resilient support sized and shaped to receive and selectively support a hose nozzle, the resilient support adapted to resiliently deform upon receiving the hose nozzle from an unbiased state;
disposing the resilient web of material of the hose holder about a portion of the vehicle;
securing the first and second ends of the web of material of the hose holder to each other and around the portion of the vehicle such that the web of material is supported by the vehicle; and
urging a hose nozzle into the resilient support of the hose holder so as to deform the resilient support such that the hose nozzle is supported by the resilient support.

2. The method of claim 1, wherein the resilient web of material of the hose holder is shaped to complement and be disposed about at least a portion of a side-view mirror of the vehicle.

3. The method of claim 1, further comprising the step of advancing the hose nozzle until the resilient support at least partially returns to the unbiased state.

4. The method of claim 1, wherein the disposing step further comprises positioning a non-marring surface of the web against a side-view mirror of the vehicle.

5. The method of claim 1, wherein the resilient support is a spring loop sized and shaped to receive a hose nozzle within the loop.

6. The method of claim 1, wherein the spring loop is supported at an upper point and a lower point.

7. The method of claim 1, wherein the resilient support is bent metal receptacle sized and shaped to receive a hose nozzle within the loop.

8. The method of claim 4, wherein the resilient support is bent metal receptacle includes two upright portions connected at adjacent ends by a curved portion, wherein the curved portion allows the two upright portions to flex away from each other to receive and secure a hose nozzle.

9. The method of claim 1, wherein the releasable attachments are hook and loop fasteners.

10. The method of claim 1, wherein the resilient web of material is a stretchable fabric.

11. The method of claim 1, wherein the resilient web of material is neoprene.

12. The method of claim 1, wherein the resilient web of material includes a non-slip surface arranged to contact the vehicle when the web of material is disposed thereabout.

13. A hose holder, comprising:
a resilient web of material having first and second end portions;
releasable attachments disposed on the first and second end portions that permit securement of the first and second end portions to each other; and
a resilient support connected to the resilient web of material, the resilient support sized and shaped to receive and selectively support a hose nozzle, the resilient support adapted to resiliently deform upon receiving the hose nozzle.

14. A method of securing a hose to a vehicle, comprising the steps of:
providing a hose holder comprising:
a resilient web of material having first and second end portions;
releasable attachments disposed on the first and second end portions that permit securement of the first and second end portions to each other; and
a first support connected to the resilient web of material;
a second support sized and shaped to be connected to a hose nozzle, wherein the first and second supports are configured for releasable engagement;
disposing the resilient web of material of the hose holder about a portion of the vehicle;
securing the first and second ends of the web of material of the hose holder to each other and around the portion of the vehicle such that the web of material is supported by the vehicle;
securing the second support to a nozzle of a hose; and
engaging the first and second supports.

15. The method of claim 14, wherein the resilient web of material of the hose holder is shaped to complement and be disposed about at least a portion of a side-view minor of the vehicle.

16. The method of claim 14, wherein the disposing step further comprises positioning a non-marring surface of the web against the vehicle.

17. The method of claim 1, wherein the releasable attachments are hook and loop fasteners.

18. The method of claim 1, wherein the first and second supports include a hook and loop adapted for releasable engagement.

19. The method of claim 1, wherein the first and second supports include magnets adapted for releasable engagement.

20. The method of claim 1, wherein the first and second supports include a hook and loop fasteners adapted for releasable engagement.
